(19) United States
(12) Patent Application Publication
(10) Pub. No.: US 2008/0283667 A1
(43) Pub. Date: Nov. 20, 2008

(54) HYBRID COMPOSITE-METAL AIRCRAFT LANDING GEAR AND ENGINE SUPPORT BEAMS

(75) Inventor: Donald C. Darrow, Grand Prairie, TX (US)

Correspondence Address: ALSTON & BIRD, LLP, BANK OF AMERICA PLAZA, 101 SOUTH TRYON STREET, SUITE 4000, CHARLOTTE, NC, 28280-4000, US

(73) Assignee: THE BOEING COMPANY

(21) Appl. No.: 11/608,534

(22) Filed: Dec. 8, 2006

(51) Int. Cl. B64C 25/00

(52) U.S. Cl. 244/133; 244/100 R

(57) ABSTRACT

A hybrid composite-metal component is provided. The component includes an elongate inner metal piece, an outer metal piece disposed about at least a portion of the inner metal piece, and composite material disposed between the inner metal piece and the outer metal piece. The component may further include at least one of a seal and at least one fastener joining the inner metal piece and outer metal piece. Both the inner metal piece and the outer metal piece may include at least one tapered end. The tapered ends of both the inner metal piece and the outer metal piece each may include a double taper.

### BACKGROUND

1) Technical Field

Embodiments of the disclosure relate to the formation of a hybrid composite-metal part and, more particularly, to apparatus and methods for forming a hybrid composite-metal aircraft landing gear and engine support beams.

2) Description of Related Art

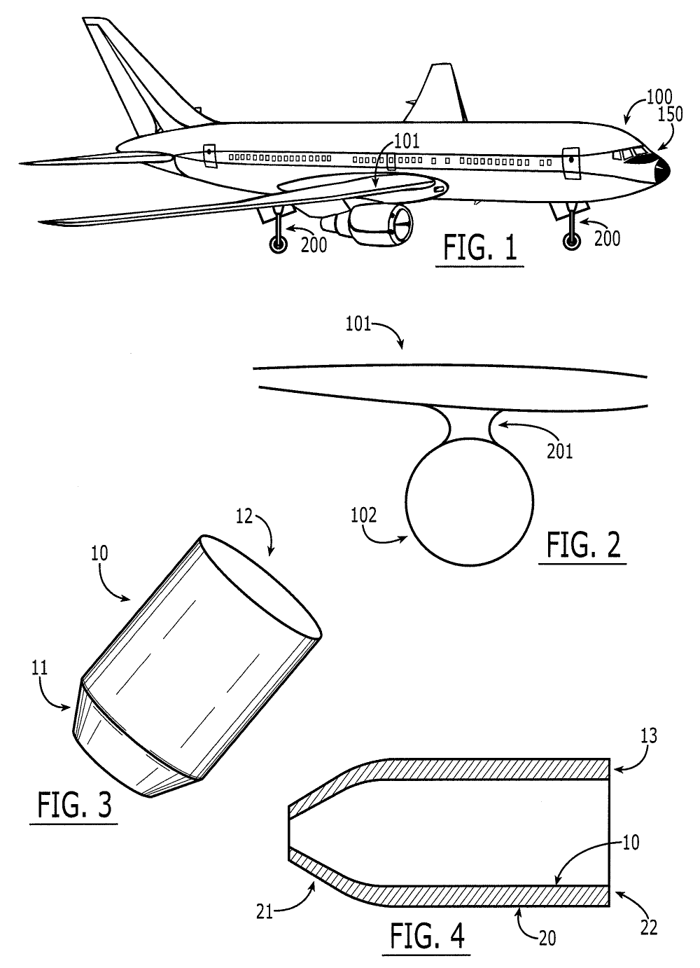

In many applications, particularly in the aviation, marine, space, and construction industries, it is important to provide parts with certain properties, such as strength, but with the least amount or at least a reduced amount of mass. Landing gears and engine support beams are commonly heavy metallic structures. For example, there is shown in FIG. 1 an airplane 100 with landing gears 200. A landing gear 200 is roughly below cockpit area 150. The main landing gear 200 of FIG. 1 is situated proximate an airplane wing 101. In FIG. 2, an aircraft engine 102 is supported by engine support beam 201 that is proximate airplane wing 101. A landing gear made of metal provides the necessary protection from impact caused by debris on the runway. Also, the benefit of using metal is the ability to support or restrain the main load. Of course, a large drawback of using metal is the mass needed to achieve these structural objectives. Typically, landing gears and engine support beams formed of metal, therefore, require difficult tailoring and have other design issues since the design requirements call for lightweight structures.

The requirements for resisting compression, bending, torsion loads, and runway debris in a landing gear have created a need for a new landing gear design. The new landing gear design must meet the standard requirements but with less mass. Prior and emerging art, using an all metal or all composite structure, have provided limited capabilities to complete these requirements. Namely, composite structures are lighter in weight than metal structures but require expensive molds or tools for their fabrication and autoclaves or presses for their cure processing. In addition, composite structures are susceptible to impact damage and may not be able to support the weight of an entire aircraft. As such, metal has remained the material of choice for the landing gear even though it has a weight disadvantage. Thus, the dead weight of the landing gear remains a problem for the aviation industry.

The requirements for the engine support beams are similar to those for the landing gear design. The engine support beams must provide enough support to effectively resist the various loads caused by the engine including pitch and side loads. As was the case for landing gears, it is desirable to reduce the weight of the engine support structure as much as possible without critically reducing the ability of the structure to achieve its load requirements. As such, the need exists for a new engine support beam design to reduce mass. Prior and emerging art have provided limited capabilities to complete the requirements. Typically, engine supports are made of metal. Metal supports do not require the expensive molds or tools used in fabrication of composite supports. As such, metal is still the material of choice for engine support beams. Thus, the weight of engine support beams continues to be a problem for designers.

It would therefore be advantageous to provide apparatus and methods for forming hybrid components that enjoy at least some of the strength offered by conventional metal components and at least some of the weight advantages offered by composite components. In addition, it would be advantageous to provide apparatus and methods to form components that decrease the overall weight of an aircraft or other vehicles without compromising its structural integrity. With less structural weight, aircraft and other vehicles would be able to carry greater payloads and realize increased fuel economy.

### SUMMARY

Embodiments of the disclosure may address the above needs and achieve other advantages by providing apparatus and methods for formation of a hybrid composite-metal part, such as a hybrid composite-metal aircraft landing gear and engine support beams. Generally, embodiments of the disclosure provide apparatus and methods for forming a hybrid composite-metal part without the need for tooling or autoclave processing while benefiting from the properties and characteristics of both composite and metal materials. In particular, hybrid composite-metal parts may be formed of metal pieces joined together with a cured composite occupying the space between the pieces.

In one embodiment, a hybrid composite-metal component includes an elongate inner metal piece, an outer metal piece disposed about at least a portion of the inner metal piece, and composite material disposed between the inner metal piece and the outer metal piece. The inner metal piece and outer metal piece may have opposed tapered and non-tapered ends. The length defined by the distance from the tapered end to the non-tapered end of the inner metal piece may be about the same as the length defined by the distance from the tapered end to the non-tapered end of the outer metal piece. The inner metal piece and outer metal piece may be joined by at least one of a seal and at least one fastener, which may be a bolt extending between the inner metal piece and outer metal piece or a plurality of fasteners spaced evenly about a section of the outer metal piece. The inner metal piece and the outer metal piece may be formed of titanium. The composite material may be formed of graphite impregnated with resin. The tapered ends of both the inner metal piece and outer metal piece may include a double taper. Also, the tapered ends of the inner metal piece and outer metal piece may be aligned, while the non-tapered ends are also aligned.

In another embodiment, a method of forming a hybrid composite-metal component is provided. The method includes mating an inner metal piece within an outer metal piece so that there is a gap therebetween, filling at least a portion of the gap with a composite material, and joining the inner metal piece and the outer metal piece. The joining of the inner metal piece and the outer metal piece may include at least one of applying a seal and attaching at least one fastener. Attaching at least one fastener may include affixing at least one bolt to the inner metal piece and the outer metal piece, as well as affixing a plurality of bolts spaced evenly about the outer metal piece. The filling at least a portion of the gap with composite material includes depositing a dry composite material within the gap and impregnating the dry composite material with a resin. The method further includes curing the composite material. The curing of the composite material may include applying heat or radiation to the composite material. Also, the method may include applying pressure to the composite material during the curing of the composite material.

In another embodiment, an aircraft component is provided. The aircraft component includes an inner metal tube, an outer metal tube disposed about at least a portion of the inner metal tube, and composite material disposed between the inner metal tube and the outer metal tube. As before, both the inner metal tube and the outer metal tube may have at least one tapered end. The tapered ends of both the inner metal tube and outer metal tube may each include a double taper.

### BRIEF DESCRIPTION ILLUSTRATIONS

Having thus described the embodiments of the disclosure in general terms, reference will now be made to the accompanying illustrations, which are not necessarily drawn to scale, and wherein:

FIG. 1 is an illustration of an aircraft showing a landing gear below the cockpit area and a main landing gear proximate the wing.

FIG. 2 is an illustration of an engine support beam proximate an aircraft engine and wing.

FIG. 3 is a perspective illustration of an elongate inner metal piece.

FIG. 4 is a section illustration of an elongate inner metal piece with an outer metal piece disposed about a portion of the inner metal piece.

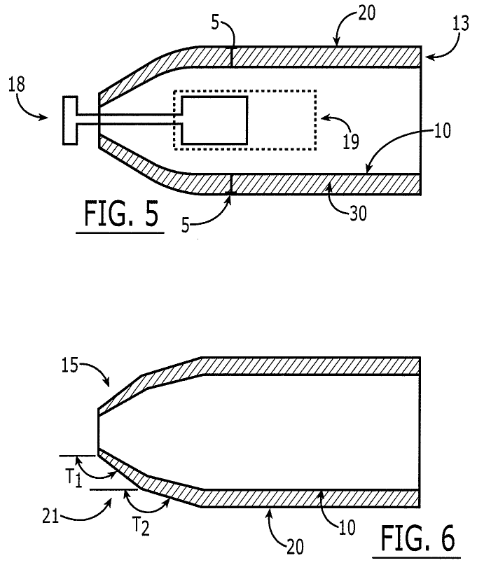

FIG. 5 is a section illustration of an elongate inner metal piece with an outer metal piece disposed about a portion of the inner metal piece and composite material disposed between the inner metal piece and outer metal piece in accordance with embodiments.

FIG. 6 is a section illustration showing a piston disposed within a portion of the inner metal piece.

### DETAILED DESCRIPTION

The embodiments will now be described more fully hereinafter with reference to the accompanying illustrations, in which some, but not all embodiments are shown. Indeed, these embodiments may be embodied in many different forms and should not be construed as limited to the embodiments set forth herein; rather, these embodiments are provided so that this disclosure will satisfy applicable legal requirements. Like numbers refer to like elements throughout.

A hybrid composite-metal component is provided that can be employed in various applications and may serve, for example, as landing gear main posts and trucks or an engine support beam for aircraft. The hybrid composite-metal component includes an elongated inner metal piece 10 that may have a tapered end 11 and an opposed non-tapered end 12 as shown in FIG. 3. The elongated inner metal piece 10 may be formed of various metals including, for example, titanium. The elongated inner metal piece 10 may be either solid or hollow. It may be cylindrical in shape as seen in FIG. 6 but may be other shapes as well. The hybrid composite-metal component also includes an outer metal piece 20. In this regard, FIG. 4 shows an outer metal piece 20 with a tapered end 21 and non-tapered end 22. The outer metal piece 20 is generally hollow and may be cylindrical with an inner diameter that is greater than the outer diameter of the inner metal piece 10. As such, the outer metal piece 20 may be disposed about a portion, if not all, of the inner metal piece 10. The outer metal piece 20 may embody shapes other than a cylinder. Typically, the length of outer metal piece 20 is greater than or equal to the length of inner metal piece 10 so that inner metal piece 10 can fit within outer metal piece 20. The outer metal piece 20 may be formed of various metals including, for example, titanium. In this regard, the inner metal piece 10 and outer metal piece 20 may be formed of the same or different metals. The inner diameter of the outer metal piece 20 is generally greater than the outer diameter of the inner metal piece 10 so as to define a gap 13 therebetween.

As shown in FIG. 5, the gap 13 between outer metal piece 20 and inner metal piece 10 is filled with composite material 30. The composite material 30 may include various composite materials, such as graphite impregnated with resin. Typically, filling the gap 13 with composite material 30 involves loading composite fibers or other dry composite material into the gap 13, such as by filament winding, braiding, or hand placement, and then transferring a resin into the gap 13. Once the composite material 30 has been placed in the gap 13 and resin has been transferred therein, the composite material 30 may be cured by heating, such as by radiation. FIG. 5 also shows a piston 18 partially disposed within inner metal piece 10 and a portion of the piston 18 is disposed within an air cylinder 19. Piston 18 may be used to assist with resin transfer, such as providing tension. While FIG. 5 shows just one piston 18 partially disposed within inner metal piece 10, other embodiments may contain two or more pistons 18 at least partially disposed within inner metal piece 10, for example, two pistons 18 partially disposed within opposing ends of inner metal piece 10.

Typically, the composite material 30 substantially or completely fills the gap 13. The width of the gap 13 differs depending upon the application, particularly the load requirements. For instance, larger and heavier aircraft require greater composite thicknesses to provide the necessary strength to resist loads imposed on the aircraft by hard landings at maximum gross weights. The surfaces of the metal components that contact the composite resin material may be etched and adhesive bond primed to provide high bond strengths. The outer metal piece 20 and inner metal piece 10 are also typically joined by fasteners, such as bolts 5. In one embodiment, for example, the outer metal piece 20 and inner metal piece 10 may be joined by a plurality of bolts 5 spread circumferentially about the outer metal piece 20 surface. Typically, the bolts 5 are spaced in an even manner about the circumference of the outer metal piece 20, but bolts 5 can be spaced irregularly if desired. Large diameter fasteners may be used, particularly to resist torsion and side loads. In addition or alternatively, outer metal piece 20 and inner metal piece 10 can be joined by a seal. The seal is typically a high temperature resistant seal, such as a polyimide. The inside surface of the outer metal piece 20 and outside surface of the inner metal piece 10 may have a layer of Teflon® applied to shield the two surfaces. The Teflon® may be removed after cure. In addition or alternatively, the outer metal piece 20 and inner metal piece 10 may include threaded metal components.

In FIG. 6, the outer metal piece 20 has a double taper 15. The double taper 15 is illustrated in FIG. 6 as the two different taper angles T1,T2 across the taper section 21. As shown, the endmost taper, or the taper defining taper angle T2, is generally greater, i.e., at a greater angle with respect to the longitudinal axis defined by the inner metal piece 10 or the outer metal piece 20, than the other taper. A double taper 15 may provide a desired loading condition for the composite material 30.

Many modifications and other embodiments will come to mind to one skilled in the art to which these embodiments pertain having the benefit of the teachings presented in the foregoing descriptions and the associated drawings. For example, one or both of the inner metal piece 10 and the outer metal piece 20 need not have tapered ends 11 and may either have cylindrical or even outwardly flared ends. Moreover, while a cylindrical inner metal piece 10 and a cylindrical outer metal piece 20 have been illustrated and described, one or both of the inner metal piece 10 and the outer metal piece 20 may have other cross sectional shapes and the inner metal piece 10 and the outer metal piece 20 may have different cross-sectional shapes so long as the inner metal piece 10 fits, at least partially, within the outer metal piece 20. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A hybrid composite-metal component comprising:
an elongate inner metal piece;
an outer metal piece disposed about at least a portion of the inner metal piece; and
composite material disposed between the inner metal piece and the outer metal piece.

2. A hybrid composite-metal component according to claim 1 wherein both the inner metal piece and the outer metal piece have opposed tapered and non-tapered ends.

3. A hybrid composite-metal component according to claim 2 wherein the inner metal piece and outer metal piece are joined so that the tapered end of the inner metal piece is aligned with the tapered end of the outer metal piece and the non-tapered end of the inner metal piece is aligned with the non-tapered end of the outer metal piece.

4. A hybrid composite-metal component according to claim 2 wherein the tapered ends of both the inner metal piece and the outer metal piece each comprise a double taper.

5. A hybrid composite-metal component according to claim 1 wherein the composite material comprises graphite impregnated with resin.

6. A hybrid composite-metal component according to claim 1 further comprising at least one of a seal and at least one fastener joining the inner metal piece and outer metal piece.

7. A hybrid composite-metal component according to claim 6 wherein the at least one fastener comprises a bolt extending between the inner metal piece and outer metal piece.

8. A hybrid composite-metal component according to claim 6 wherein the at least one fastener comprises a plurality of fasteners spaced evenly about a section of the outer metal piece.

9. A hybrid composite-metal component according to claim 1 wherein the inner metal piece comprises a titanium piece.

10. A hybrid composite-metal component according to claim 1 wherein the outer metal piece comprises a titanium piece.

11. A method of forming a hybrid composite-metal component comprising:
mating an inner metal piece within an outer metal piece so that there is a gap therebetween;
filling at least a portion of the gap with a composite material;
joining the inner metal piece and the outer metal piece; and
curing the composite material;
wherein filling at least a portion of the gap with composite material comprises depositing a dry composite material within the gap and wherein the method further comprises subsequently impregnating the dry composite material with a resin.

12. A method of forming a hybrid composite-metal component according to claim 11 wherein joining the inner metal piece and the outer metal piece comprises at least one of applying a seal and attaching at least one fastener.

13. A method of forming a hybrid composite-metal component according to claim 12 wherein attaching at least one fastener comprises affixing at least one bolt to the inner metal piece and the outer metal piece.

14. A method of forming a hybrid composite-metal component according to claim 12 wherein attaching at least one fastener comprises affixing a plurality of bolts spaced evenly about the outer metal piece.

15. A method of forming a hybrid composite-metal component according to claim 11 wherein curing the composite material comprises applying radiation to the composite material.

16. A method of forming a hybrid composite-metal component according to claim 11 wherein curing the composite material comprises applying heat to the composite material.

17. A method of forming a hybrid composite-metal component according to claim 11 further comprising moving a piston configured within the inner metal piece.

18. An aircraft component comprising:
an inner metal tube;
an outer metal tube disposed about at least a portion of the inner metal tube; and
composite material disposed between the inner metal tube and the outer metal tube.

19. An aircraft component according to claim 18 wherein both the inner metal tube and the outer metal tube have at least one tapered end.

20. An aircraft component according to claim 19 wherein the tapered ends of both the inner metal tube and the outer metal tube each comprise a double taper.
